(19) United States
(12) Patent Application Publication
(10) Pub. No.: US 2021/0274721 A1
(43) Pub. Date: Sep. 9, 2021

(54) DEVICE FOR IMPROVING POWER EFFICIENCY OF A GROW LIGHT FOR PLANTS

(71) Applicant: ARTLED TECHNOLOGY CORP., Taoyuan City (TW)

(72) Inventor: Chia-Tsung Tsao, Taipei (TW)

(21) Appl. No.: 16/807,346

(22) Filed: Mar. 3, 2020

(51) Int. Cl. A01G 7/04; F21V 21/24

(52) U.S. Cl. CPC A01G 7/045; F21V 21/24

(57) ABSTRACT

The present invention is a device for improving power efficiency of a grow light for plants which includes a scissor extension, a base and a control device having a cable, wherein the control device controls the available cable length of the cable. One end of the scissor extension is connected to the control device, the other end connected to the base. The cable also connects the control device and the base. The base is suspended below the control device by the scissor extension and the cable. The control device controls the distance between the control device and the base by changing the available cable length, wherein a sensing device and a light fixture are connected below the base, and the control device controls the distance according to the relative position between the sensing device and a plant below measured by the sensing device.

### BACKGROUND OF THE INVENTION

### 1. Field of the Invention

The present invention relates to a device for improving power efficiency, especially a device for improving power efficiency of a grow light for plants.

### 2. Description of the Prior Arts

Please refer to FIGS. 1A-1C. A conventional grow light is used to provide light energy to a plant lacking sunlight to enable it to perform photosynthesis and to continue to grow. In order to improve the irradiation efficiency, the grow light is usually located directly above the plant, so that the light emitted by the grow light can be irradiated on the plant to the greatest extent. The distance between the grow light and the top of the plant is also desired to be the shorter the better under the premise of not contacting each other, and conventionally, the height of the grow light from the ground is usually a fixed height, which must be higher than the maximum height of the plant.

When a young plant has been irradiated by a grow light for a long time, the plant will gradually grow taller, so the distance between the grow light and the top of the plant will change as the plant grows. For example, a distance H1 between the top of a young plant P1 and a grow light L1 is shown in FIG. 1A. When the young plant P1 continues to grow, it will become a growing plant P2 and a distance H2 between the top of the growing plant P2 and the grow light L1 is shown in FIG. 1B. If the growing plant P2 continues to grow, it will become a mature plant P3 and a distance H3 between the top of the mature plant P3 and the grow light L1 is shown in FIG. 1C. The distance H1 is greater than the distance H2 and the distance H2 is greater than the distance H3.

As shown in FIGS. 1A-1C, since the distances H1>H2>H3, it can be simply inferred that the light shining on the mature plant P3 is the most, the growing plant P2 the second, the young plant P1 the least, and the irradiation efficiency of the young plant P1 when irradiated by the grow light L1 is relatively lower than that of the growing plant P2, and the irradiation efficiency of the growing plant P2 when irradiated by the grow light L1 is relatively lower than that of the mature plant P3; hence, how to improve the irradiation efficiency of the young plant P1 and the growing plant P2 when irradiated by the grow light L1 is an area for improvement for the conventional grow light setting.

### SUMMARY OF THE INVENTION

In view of the foregoing shortcomings of the prior art, the present invention provides a device for improving the power efficiency of a grow light, so that the distance between the top of a plant and a grow light can be maintained at a preferred fixed value. When the plant is illuminated by the grow light, the irradiation efficiency will not be changed due to the change in the height of the plant, and accordingly the irradiation efficiency can be maintained at an optimum to save power consumption.

In order to achieve the above-mentioned objectives of the present invention, the technical means adopted in present invention is to design a device for improving power efficiency of a grow light, which is used to set up a sensing device and a light fixture, and said device comprises:

a device for improving power efficiency of the grow light, the device used for setting a sensing device and a light fixture, and the device including:

a control device having at least one cable, each of the at least one cable having two ends, one end of which is controlled by the control device to change an available cable length of each of the at least one cable;

at least one scissor extension, each of the at least one scissor extension having two ends, one of which is connected to the control device;

a base that is connected to both the other end of each of the at least one scissor extension and the other end of each of the at least one cable;

wherein the base is suspended below the control device by the at least one scissor extension and the at least one cable, and the distance between the control device and the base is changeable by changing the available cable length of each of the at least one cable;

wherein the sensing device and the light fixture are further connected under the base.

The control device further includes:

a bottom plate having:
a rotating shaft, which is elongated and has two ends;
a motor that provides a torque to the rotating shaft;
a bearing, together with the motor respectively pivotally connected with the two ends of the rotating shaft, and the rotating shaft being rotatable by the motor;
a control module, which controls the motor to rotate in a first rotation direction or a second rotation direction;
a spool fixed on the rotating shaft and being rotatable with the rotating shaft;

wherein the end of each of the at least one cable is wound around the spool, and is controlled by the control device, such that each of the at least one cable is further wound around or loosened from the spool;

wherein, when the control module controls the motor to rotate in the first rotation direction, each of the at least one cable is further wound around the spool, so that the available cable length of each of the at least one cable is getting shorter, and when the control module controls the motor to rotate in the second rotation direction, each of the at least one cable is released from the spool, so that the available cable length of each of the at least one cable is getting longer.

Each of the at least one scissor extension further includes:

at least one outer scissor arm, each of which is elongated and has two ends and a middle section, and each of the two ends and the middle section having a respective hole;

at least one inner scissor arm, each of which is elongated and has two ends and a middle section, and each of the two ends and the middle section having a respective hole;

wherein each of the at least one outer scissor arm is pivotally connected with a corresponding one of the at least one inner scissor arm through the holes at the middle section to form at least one scissors structure, and the at least one scissors structure is further pivotally connected with the outer scissor arm and the inner scissor arm through the holes at both ends of the outer scissor arm and the inner scissor arm to form at least one set of connected multi-piece scissors structure.

The base further includes:

a bottom surface, correspondingly provided with a cable fixing hole for each of the at least one cable;

at least one sidewall, each of which is provided with a slide slot and a fixing hole;

wherein one of the at least one scissor extension and one of the at least one sidewall of the base are pivotally connected via the slide slot and the fixing hole, and the other end of each of the at least one cable is fixed on the bottom surface through the corresponding cable fixing hole.

The sensing device can further measure a relative position between a plant and the sensing device, and transmit information of the measured relative position to the control module, and the control module can adjust the distance between the light fixture and the plant by controlling the available cable length of each of the at least one cable according to the information of the relative position.

The advantage of the present invention is that the device for improving power efficiency of a grow light can automatically detect the distance between the light sensor and the plant, so it can automatically control the distance between the light source and the plant at a fixed distance regardless of the growth conditions of the plant, such that the amount of light received by the plant can be kept steady and the energy efficiency of the light from the light source and absorbed by the plant can be maintained at a preferred high efficiency state. Therefore, the present invention can solve the problem of low efficiency of the conventional grow light setup.

Other objectives, advantages and novel features of the present invention will become more apparent from the following detailed description when taken in conjunction with the accompanying drawings.

### BRIEF DESCRIPTION OF THE DRAWINGS

FIGS. 1A to 1C are schematic diagrams of a conventional grow light;

FIGS. 2A to 2C are schematic diagrams of the device for improving power efficiency of a grow light of the present invention;

FIGS. 3A to 3B are comparison diagrams for the present invention and the prior art;

FIGS. 4A to 4I are schematic diagrams of a first embodiment of the present invention;

FIGS. 5A to 5B are schematic diagrams of a second embodiment of the present invention;

FIGS. 6A to 6B are schematic diagrams of a third embodiment of the present invention.

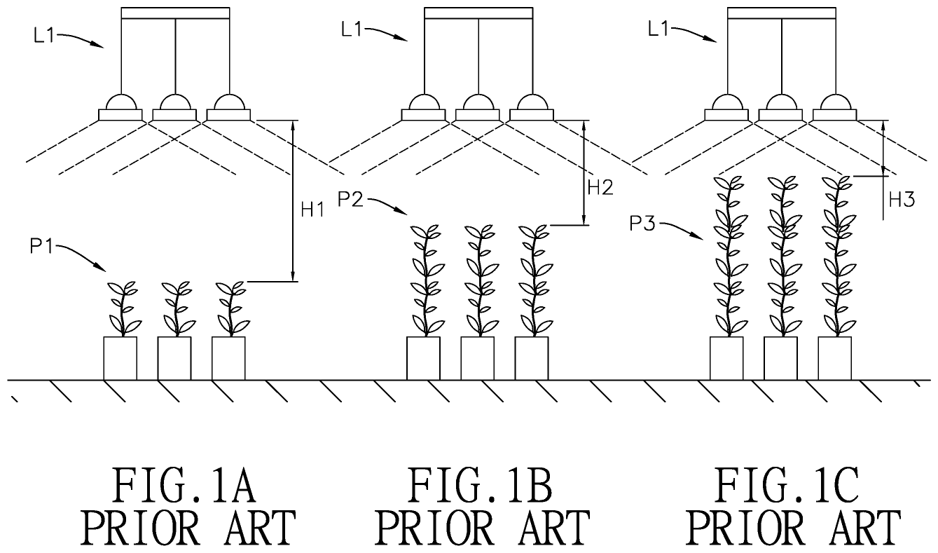

### DETAILED DESCRIPTION OF THE PREFERRED EMBODIMENTS

The following, with the drawings and the preferred embodiments of the present invention, further illustrates the technical means that the present invention adopts to achieve the intended purpose.

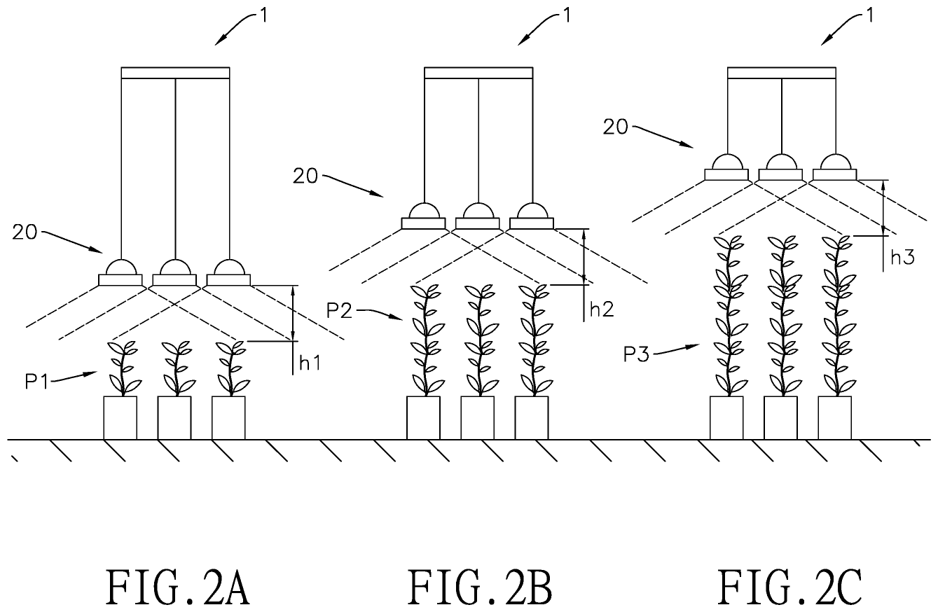

Please refer to FIGS. 2A to 2C. FIGS. 2A to 2C are schematic diagrams of the device for improving power efficiency of a grow light of the present invention. FIG. 2A shows a young plant P1, a device 1 for improving power efficiency of a grow light, and a light source 20, wherein the light source 20 is a grow light for providing light energy required for plant growth, and the light source 20 is suspended underneath the device 1 for improving power efficiency of a grow light, and the device 1 for improving power efficiency of a grow light can change the height of the light source 20 so that a distance h1 is between the light source 20 and the top of the young plant P1. Similarly, FIG. 2B shows a growing plant P2, and the device 1 for improving power efficiency of a grow light can change the height of the light source 20 so that a distance h2 is between the light source 20 and the top of the growing plant P2. FIG. 2C shows a mature plant P3, and the device 1 for improving power efficiency of a grow light can change the height of the light source 20, so that a distance h3 is between the light source 20 and the top of the mature plant P3. Since the device 1 for improving power efficiency of a grow light can change the height of the light source 20, the distances h1, h2, and h3 can be adjusted to be the same, that is, h1=h2=h3, thereby achieving the objectives of the present invention which is to avoid the change of the irradiation efficiency of a plant when irradiated by a light source due to the change in the height of the plant and simultaneously maintaining a preferred irradiation efficiency to save power consumption.

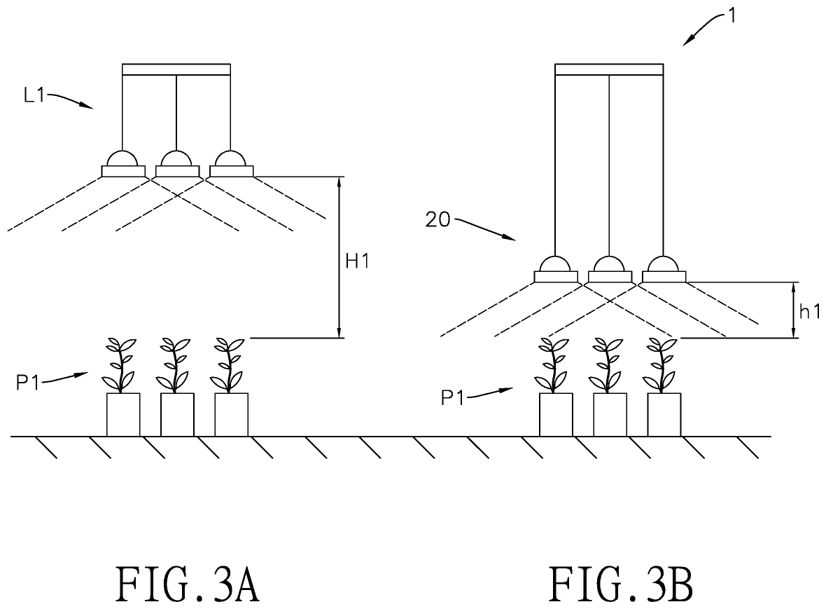

Please refer to FIGS. 3A and 3B. FIGS. 3A to 3B are comparison diagrams for the present invention and the prior art. FIG. 3A shows a young plant P1 and a conventional grow light L1. A distance H1 is between the top of the young plant P1 and the grow light L1. FIG. 3B shows a young plant P1, the device 1 for improving power efficiency of a grow light, and the light source 20. A distance h1 is between the light source 20 and the top of the young plant P1. Because the device 1 for improving power efficiency of a grow light can change the height of the light source 20, the distance h1 can be adjusted to be smaller than the distance H1. Therefore, the present invention overcomes the low irradiation efficiency of the conventional technology which is caused by inability to adjust the distance between the conventional grow light L1 and the top of the plant.

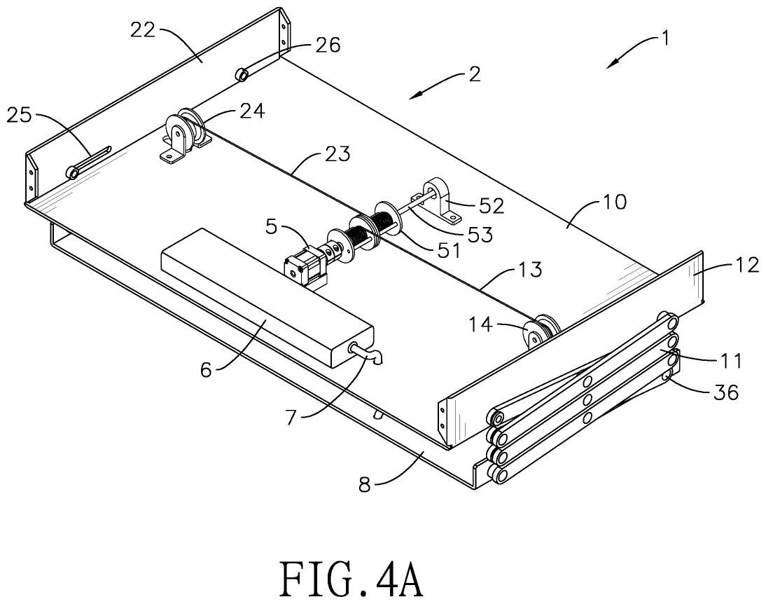

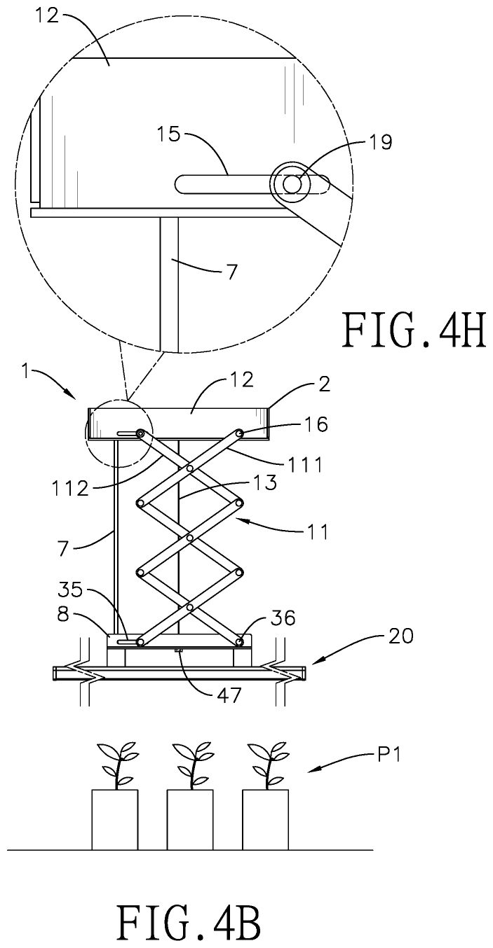

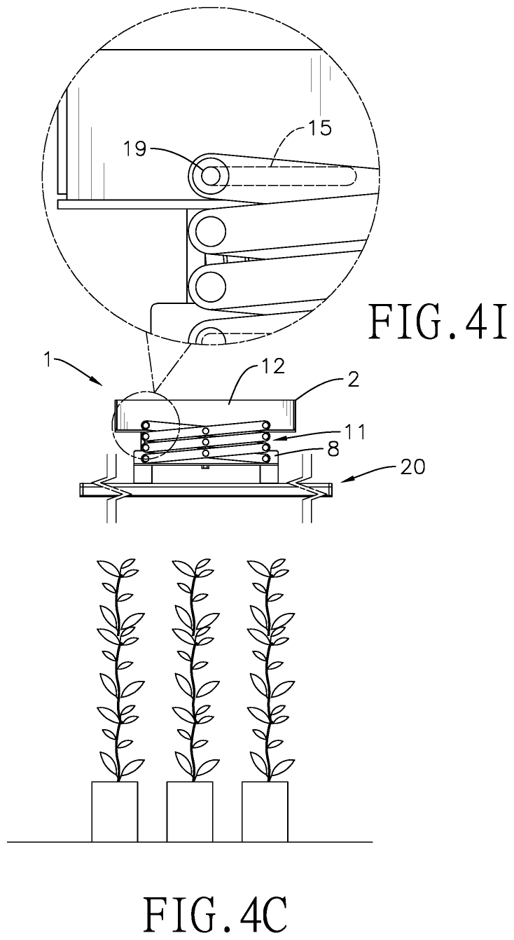

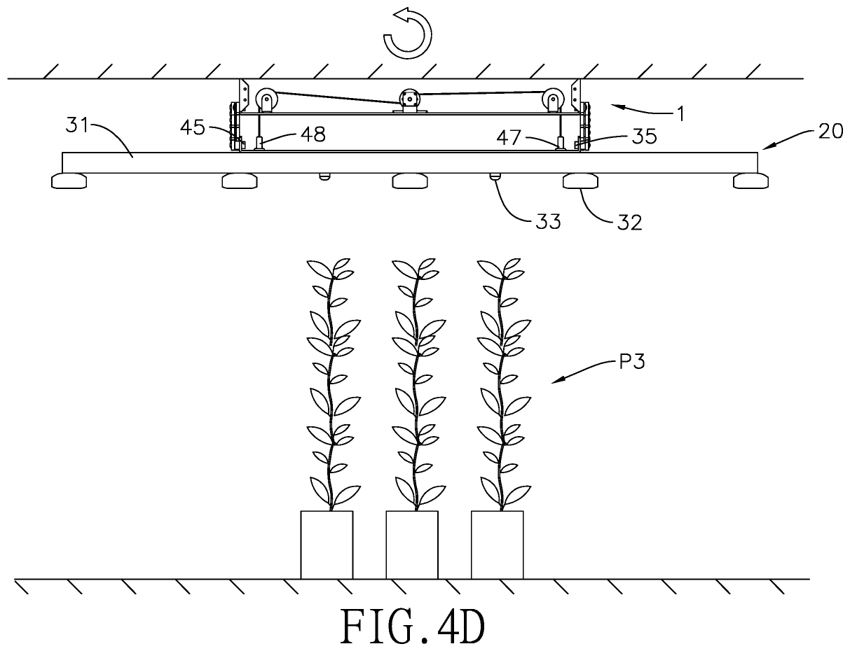

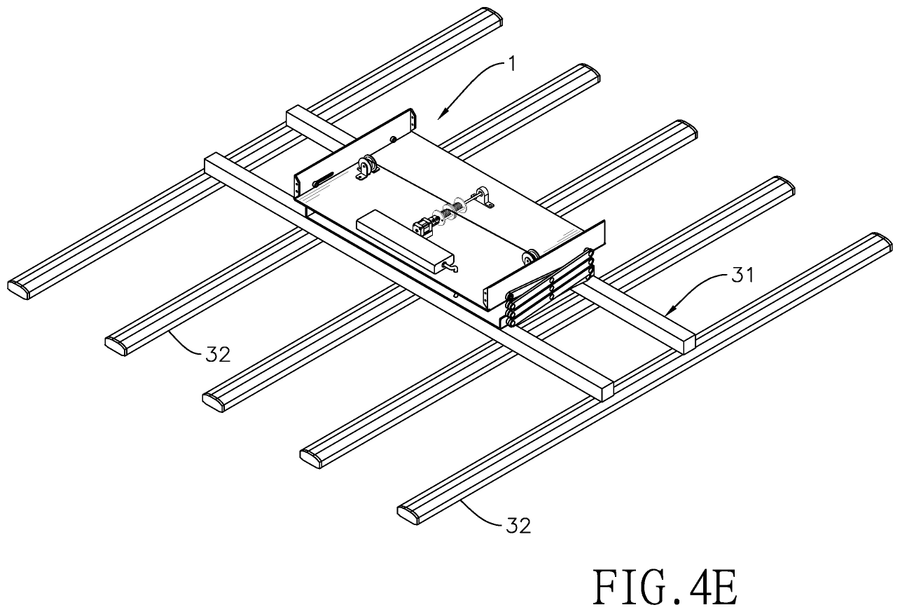

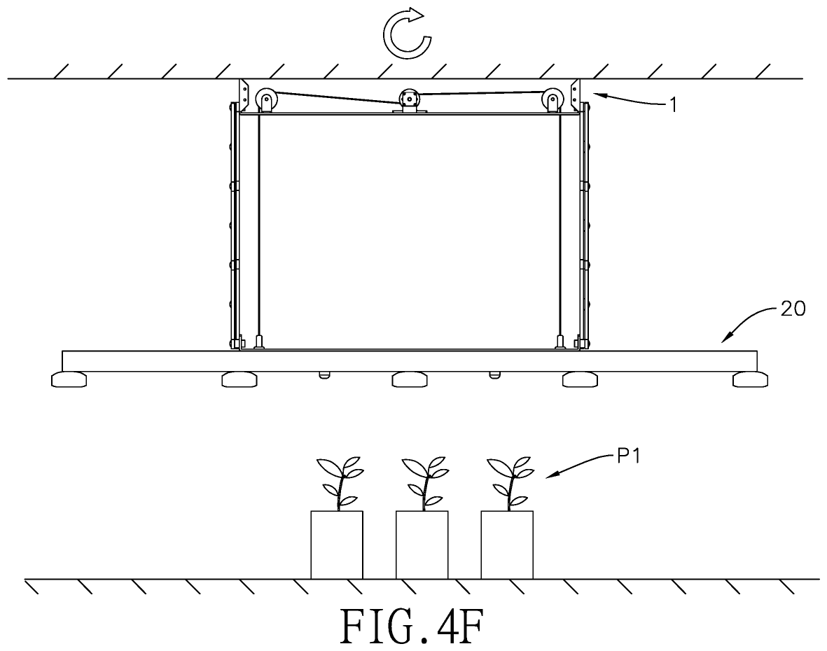

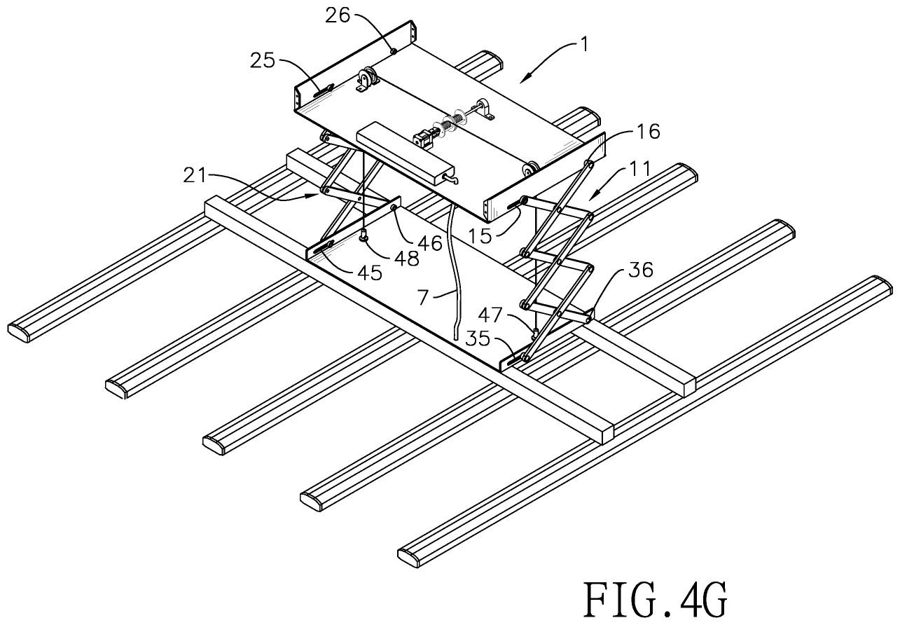

Please refer to FIGS. 4A to 4I. FIGS. 4A to 4I are schematic diagrams of the first embodiment of the present invention. FIG. 4A is a schematic diagram of the device 1 for improving power efficiency of a grow light. The device 1 for improving power efficiency of a grow light includes: a control device 2, a first scissor extension 11, a second scissor extension 21 (see FIG. 4G), and a base 8. One sidewall of the base 8 is provided with a third slide slot 35 and a third fixing hole 36, and the other sidewall of the base 8 is provided with a fourth slide slot 45 and a fourth fixing hole 46, and a bottom surface of the base 8 is provided with a fifth fixing hole 47 and a sixth fixing hole 48.

The control device 2 has a bottom plate 10, a first sidewall 12, and a second sidewall 22. The bottom plate 10 has an upper surface on which a motor 5, a first spool 51, a first bearing 52, a rotating shaft 53, a control module 6, a power & signal line 7 including a power line and a signal line, a first cable 13, a second cable 23, a first idler pulley 14 and a second idler pulley 24 are disposed. The motor 5, the first spool 51, the first bearing 52 and the rotating shaft 53 are arranged along a straight line and combined into a winding device for simultaneously rolling the first cable 13 and the second cable 23. The first cable 13 and the first idler pulley 14 are disposed on one side of the winding device, and the second cable 23 and the second idler pulley 24 are symmetrically disposed on the other side of the winding device. The control module 6 is electrically connected to the motor 5. One end of the power & signal line 7 is electrically connected to the control module 6, and the other end is connected to a sensing device and a power source. The bottom plate 10 further has two opposite sides. The first sidewall 12 is provided on one of the two opposite sides of the bottom plate 10. A first slide slot 15 and a first fixing hole 16 are formed on the first sidewall 12. The second sidewall 22 is provided on the other one of the two opposite sides of the bottom plate 10. A second slide slot 25 and a second fixing hole 26 are formed on the second sidewall 22.

The first scissor extension 11 has three outer scissor arms 111 and three inner scissor arms 112. The outer scissor arms 111 and the inner scissor arms 112 are straight and each scissor arm 111, 112 has two ends. Each outer scissor arm 111 and each inner scissor arm 112 have holes at both ends and middle sections for connecting with other parts. One said outer scissor arm 111 and one said inner scissor arm 112 are pivotally connected in the middle section to form a scissors structure. The scissors structure has an included angle and two ends. The scissors structure may further connect other outer scissors arms 111 and other inner scissors arms 112 at the two ends of the scissors structure to form a connected three-piece scissors structure. The connected three-piece scissors structure as a whole has two ends. The connected three-piece scissors structure as a whole constitutes the first and second scissor extensions 11, 21; the lengths of the first and second scissor extensions 11, 21 are determined by the included angle. When the outer scissors arm 111 and the inner scissors arm 112 both tend to be horizontal (relative to the ground), the lengths of the first and second scissor extensions 11, 21 tend to be the shortest. When the outer scissor arm 111 and the inner scissor arm 112 both tend to be vertical (relative to the ground), the lengths of the first and second scissor extensions 11, 21 tend to be the longest.

One end of the first scissor extension 11 is connected with the first side wall 12 via the first slide slot 15 and the first fixing hole 16, and the other end of the first scissor extension 11 is connected with the base 8 via the third fixing hole 36 and the third slide slot 35; and one end of the second scissor extension 21 is connected with the second side wall 22 via the second slide slot 25 and the second fixing hole 26, and the other end of the second scissor extension 21 is connected with the base 8 via the fourth slide slot 45 and the fourth fixing hole 46.

Please refer to FIGS. 4A to 4C, and FIGS. 4H to 4I. FIG. 4B and FIG. 4H are schematic diagrams of the first and second scissor extensions 11, 21 when they, are extended; wherein one end of the first scissor extension 11 is connected to the first slide slot 15 via a pivot pin 19. FIG. 4C and FIG. 4I are schematic diagrams of the first and second scissor extensions 11, 21 when they are retracted. Since the first and second scissor extensions 11, 21 are fixed to the control device 2 and the two sidewalls of the base 8, the first and second scissor extensions 11, 21 have the effect of stabilizing the base 8, and can prevent the base 8 from swinging when the base 8 is hung on the control device 2.

The control module 6 of the control device 2 controls the rotation and the direction of rotation of the motor 5. The motor 5 cooperates with a first bearing 52 to rotate the rotating shaft 53. The rotating shaft 53 can rotate a first spool 51 which is fixed on and is coaxial with the rotating shaft 53. The first spool 51 is respectively wound around by one end of the first cable 13 and one end of the second cable 23, and the other end of the first cable 13 passes through the idler pulley 14 and a hole of the bottom plate 10 to be fixedly connected to the fifth fixing hole 47 of the base 8, and similarly, the other end of the second cable 23 passes through the idler pulley 24 and another hole of the bottom plate 10 to be fixedly connected to the sixth fixing hole 48 of the base 8. So when the motor 5 rotates in a first rotation direction (see FIG. 4D), the first cable 13 and the second cable 23 will continue to be wound around the first spool 51. The cable lengths of the first cable 13 and the second cable 23 that are not wound around the first spool 51 are called the available cable lengths. In this way, the available cable lengths of the first cable 13 and the second cable 23 are both shortened, so that the distance between the base 8 and the control device 2 is shortened, and the lengths of the first and second scissor extensions 11, 21 will also be decreased accordingly; similarly, when the motor 5 rotates in a second rotation direction (see FIG. 4F), the first cable 13 and the second cable 23 will continue to loosen from the first spool 51. In this way, the available cable lengths of the first cable 13 and the second cable 23 are getting longer, so that the distance between the base 8 and the control device 2 is increased, and the lengths of the first and second scissor extensions 11, 21 will be increased accordingly.

Please refer to FIGS. 4D to 4E. FIG. 4D is a schematic diagram of the relative positions of the light source 20 and the mature plant P3, when the first and second scissor extensions 11, 21 are retracted. The light source 20 has a light fixture 31, five lamps 32, and two sensing devices 33; the sensing device 33 may be a common distance sensor or a distance sensor module; the light fixture 31 is fixed under the base 8, and the five lamps 32 and two sensing devices 33 are installed under the light fixture 31; the sensing device 33 measures a relative position between the sensing devices 33 and the mature plant P3. For example, the sensing device 33 measures the distance between itself and the mature plant P3 directly below, and transmits a measured position signal back to the control module 6 through the power & signal line 7, and the control module 6 can determine and adjust the relative position between the lamp 32 and the mature plant P3 based on the position signal received. For example, the smaller of the two distances measured respectively by and between the two sensing devices 33 and the mature plant P3 directly below is determined as the distance between the lamp 32 and the mature plant P3, and the distance can be adjusted to a preset preferred distance by raising/lowering the light fixture 31. FIG. 4E is a schematic diagram of the combination of the device 1 for improving power efficiency of a grow light and the light source 20, wherein the first and second scissor extensions 11, 21 are retracted.

Please refer to FIG. 4F and FIG. 4G. FIG. 4F is a schematic diagram of the relative position of the light source 20 and the young plant P1, wherein the first and second scissor extensions 11, 21 are in an extended state. FIG. 4G is a schematic diagram of the combination of the device 1 for improving power efficiency of a grow light and the light source 20 for improving the power efficiency of the grow light, wherein the first and second scissor extensions 11, 21 are in an extended state.

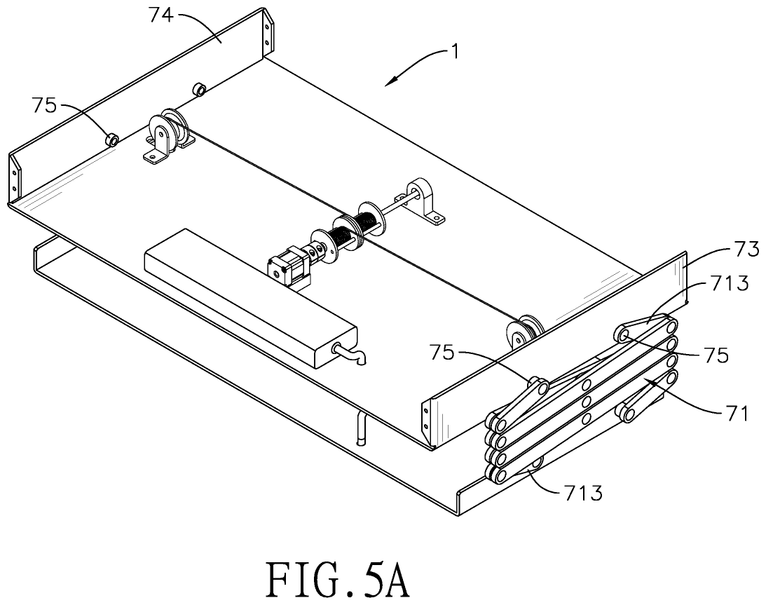

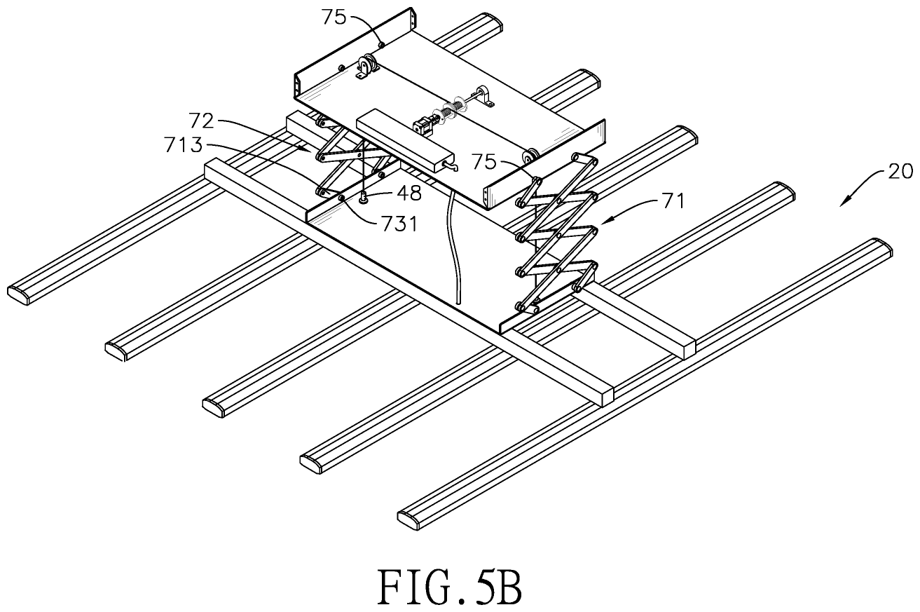

Please refer to FIG. 5A and FIG. 5B. FIG. 5A and FIG. 5B are schematic diagrams of the second embodiment of the present invention. The second embodiment of the present invention is similar to the first embodiment, however, the second embodiment of the present invention is different from the first embodiment by having a third scissor extension 71 and a fourth scissor extension 72, a third sidewall 73 and a fourth sidewall 74 of the control device 2, and two sidewalls of the base 8. The third scissor extension 71 has four connecting arms 713 in addition to the connected three-piece scissors structure. The third and fourth sidewalls 73, 74 are each provided with two ninth fixing holes 75, and the two sidewalls of the base 8 are each provided with two tenth fixing holes 731; the upper ends of the connected three-piece scissors structure are pivotally connected to two of the connecting arms 713, and then the two connecting arms 713 are respectively pivotally connected to the two ninth fixing holes 75 of the third side wall 73. The lower ends of the connected three-piece scissors structures are pivotally connected to the other two connecting arms 713, and then the two connecting arms 713 are respectively pivotally connected to the two tenth fixing holes 731 of one of the two sidewalls of the base 8; the fourth scissor extension 72 has the same structure as the third scissor extension 71 and is connected to the fourth sidewall 74 and the other of the two sidewalls of the base 8 in the same manner as that of the third scissor extension 71; hence, the detailed structure is not repeated here. FIG. 5A is a schematic view of the third and fourth scissor extensions in a retracted state. FIG. 5B is a schematic diagram of the third and fourth scissor extensions in an extended state.

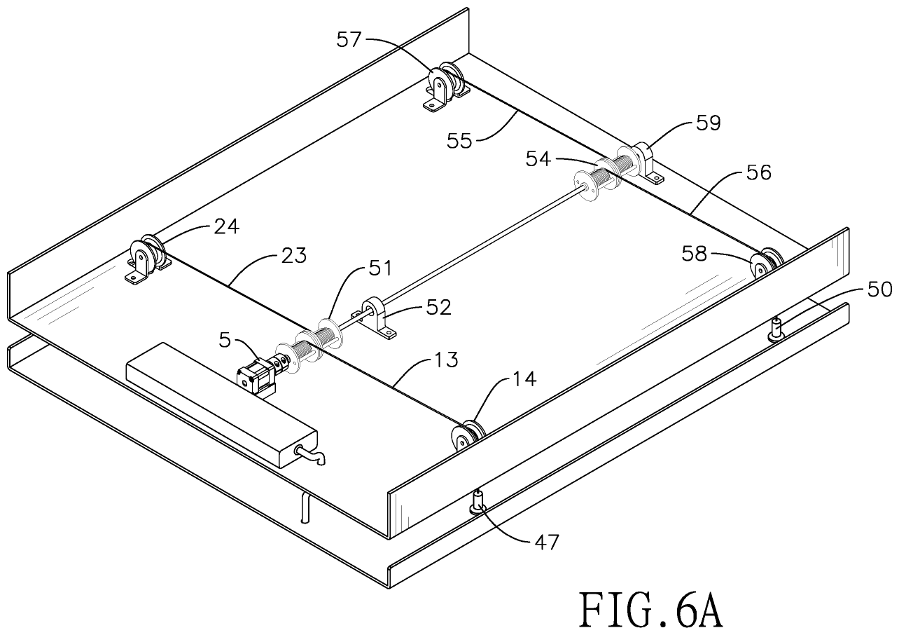

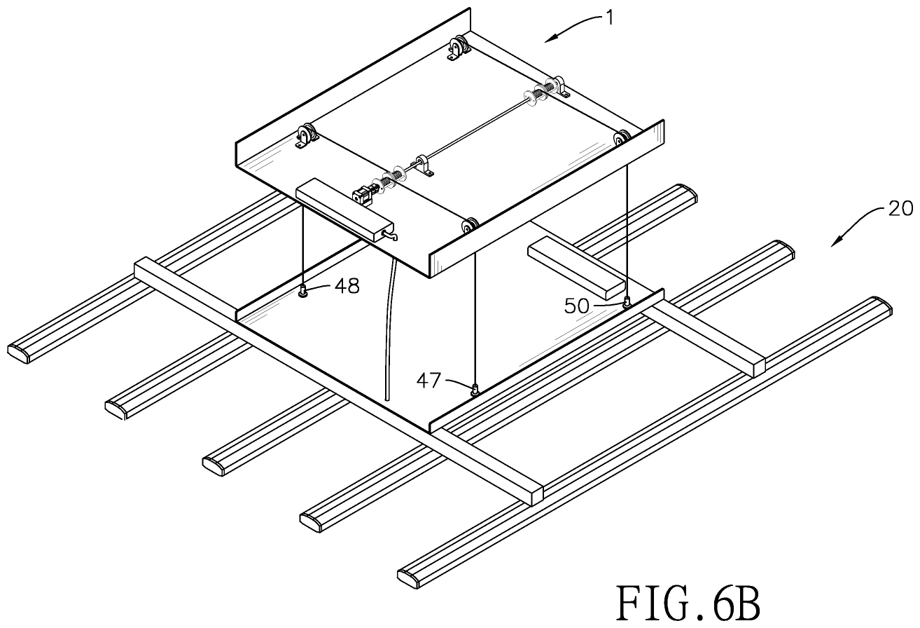

Please refer to FIGS. 6A to 6B. FIGS. 6A to 6B are schematic diagrams of the third embodiment of the present invention. The third embodiment of the present invention eliminates the scissor extensions and adds a pair of cables to hang the base 8. As shown in FIG. 6A, a second bearing 59, a second spool 54, a third cable 55, a fourth cable 56, a third idler pulley 57, a fourth idler pulley 58, a seventh fixing hole 49 (not shown) and an eighth fixing hole 50 are added to the base 8. The motor 5 of the control device 2 cooperates with the second bearing 59 to rotate the rotating shaft 53. The rotating shaft 53 can rotate a second spool 54, which is fixed on and is coaxial with the rotating shaft 53. The second spool 54 is respectively wound around by one end of the third cable 55 and one end of the fourth cable 56, and the other end of the third cable 55 passes through the idler pulley 57 and a hole in the bottom plate 10 to be fixedly connected to the seventh fixing hole 49 in the base 8, and the other end of the fourth cable 56 passes through the idler pulley 58 and another hole in the bottom plate 10 to be fixedly connected to the eighth fixing hole 50 of the base 8. So when the motor 5 rotates in a first direction (See FIG. 4D), the first cable 13 and the second cable 23 are continuously wound around the first spool 51, and the third cable 55 and the fourth cable 56 are continuously wound around the second spool 54, and that will make the available lengths of the first cable 13, the second cable 23, the third cable 55, and the fourth cable 56 shorter simultaneously, so that the distance between the base 8 and the control device 2 will be decreased accordingly; similarly, when the motor 5 rotates in a second rotation direction (see FIG. 4F), the first cable 13 and the second cable 23 will continue to loosen from the first spool 51, and the third cable 55 and the fourth cable 56 will continue to loosen from the second spool 54, and the available lengths of the first cable 13, the second cable 23, the third cable 55 and the fourth cable 56 are simultaneously getting longer so that the distance between the base 8 and the control device 2 will be increased accordingly.

Please refer to Table 1, which is a standard value of the actual light emission and power consumption of a lamp.

TABLE 1

| | lamp |
|---|---|
| | A single lamp consumes 120 watts (W) at a |
| | luminous output of 12,000 lumens (lm). |
| 5 serial cultivation racks | Light emitting angle is 120 degrees. |
| Total luminous output of | 300000 |
| 25 lamps (lm) | |
| Wattage of 25 lamps (W) | 3000 |

Please refer to Table 2. Table 2 is a comparison of the actual power efficiency of the prior art and the present invention. Table 2 is the related data of a preferred embodiment. In Table 2, when the distance between the light source and the plant is greater, the power efficiency of the light emitted by the lamp is better than that of the prior art, and the objectives of improving the power efficiency of the grow light can be achieved.

TABLE 2
Conventional technology

| | | | | |
|---|---|---|---|---|
| Distance between light source | 0.158 | 0.648 | 0.75 | 1 |
| and plant (m) | | | | |
| Amount of light received by | 274075 | 186280 | 173984 | 150237 |
| the cultivation rack (lm) | | | | |
| Average illuminance in the | 36828 | 25031 | 23378 | 20187 |
| cultivation rack range (lux) | | | | |
| Energy efficiency of lamp | 91% | 62% | 58% | 50% |
| lighting | | | | |

The present invention

| | | | | |
|---|---|---|---|---|
| Distance between light source | 0.158 | 0.158 | 0.158 | 0.158 |
| and plant (m) | | | | |
| Amount of light received by | 274075 | 274075 | 274075 | 274075 |
| the cultivation rack (lm) | | | | |
| Average illuminance in the | 36828 | 36828 | 36828 | 36828 |
| cultivation rack range (lux) | | | | |
| Energy efficiency of lamp | 91% | 91% | 91% | 91% |
| lighting | | | | |

Note:
The size of the cultivation rack in Table 2 is 1.22 × 6.1 (meter²).

Please refer to Table 3. Table 3 shows the related data when the average illuminance (lux) in the cultivation rack range is 9000 in the present invention, including the total power consumption wattage (W) of 25 lamps. Table 3 shows the related data for another preferred embodiment.

TABLE 3

| | lamp | | | |
|---|---|---|---|---|
| 5 serial | Average illuminance (lux) in the | | | |
| cultivation racks | cultivation rack range is 9000 | | | |
| Distance between light | 0.158 | 0.648 | 0.75 | 1 |
| source and plant (m) | | | | |
| Wattage of 25 lamps (W) | 733 | 1078 | 1154 | 1337 |
| Amount of light received | 66978 | 66977 | 66979 | 66980 |
| by the cultivation rack | | | | |
| (lm) | | | | |

Note:
The size of the cultivation rack in Table 3 is 1.22 × 6.1 (meter²).

From the above Tables 1 to 3, it can be known that the present invention can automatically control and adjust the distance between the light source and the plant to be a fixed distance regardless of the growth conditions of the plant. Therefore, the amount of light received by the plant can be kept constant and the plant can be illuminated by the lamps with energy consumption being maintained at high efficiency. Therefore, the present invention can solve the problem of low energy efficiency of the prior art.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. A device for improving power efficiency of a grow light, the device used for setting a sensing device and a light fixture, and the device comprising:
a control device having at least one cable, each of the at least one cable having two ends, one of which is controlled by the control device to change an available cable length of each of the at least one cable;
at least one scissor extension, each of the at least one scissor extension having two ends, one of which is connected to the control device;
a base that is connected to both the other end of each of the at least one scissor extension and the other end of each of the at least one cable;
wherein the base is suspended below the control device by the at least one scissor extension and the at least one cable, and a distance between the control device and the base is changeable by adjusting the available cable length of each of the at least one cable;
wherein the sensing device and the light fixture are further connected under the base.

2. The device for improving power efficiency of a grow light as claimed in claim 1, wherein the control device further includes:
a bottom plate having:
a rotating shaft, which is elongated and has two ends;
a motor that provides a torque to the rotating shaft;
a bearing, together with the motor respectively pivotally connected with the two ends of the rotating shaft, and the rotating shaft being rotatable by the motor;
a control module, which controls the motor to rotate in a first rotation direction or a second rotation direction;
a spool fixed on the rotating shaft and being rotated with the rotating shaft;
wherein the end of each of the at least one cable is wound around the spool, and is controlled by the control device, such that each of the at least one cable is further wound around or loosened from the spool;
wherein when the control module controls the motor to rotate in the first rotation direction, each of the at least one cable is further wound around the spool, so that an available cable length of each of the at least one cable is getting shorter, and when the control module controls the motor to rotate in the second rotation direction, each of the at least one cable is released from the spool, so that the available cable length of each of the at least one cable is getting longer.

3. The device for improving power efficiency of a grow light as claimed in claim 2, wherein each of the at least one scissor extension further includes:
at least one outer scissor arm, each of which is elongated and has two ends and a middle section, and each of the two ends and the middle section having a respective hole;
at least one inner scissor arm, each of which is elongated and has two ends and a middle section, and each of the two ends and the middle section having a respective hole;
wherein each of the at least one outer scissor arm is pivotally connected with a corresponding one of the at least one inner scissor arm through the hole at the middle section to form at least one scissors structure, and the at least one scissors structure is further pivotally connected with the outer scissor arm and the inner scissor arm through the holes at both ends of the outer scissor arm and the inner scissor arm to form at least one set of connected multi-piece scissors structure.

4. The device for improving power efficiency of a grow light as claimed in claim 3, wherein the base further includes:
a bottom surface, correspondingly provided with a cable fixing hole for each of the at least one cable;
at least one sidewall, each of which is provided with a slide slot and a fixing hole;
wherein one of the at least one scissor extension and one of the at least one sidewall of the base are pivotally connected via the slide slot and the fixing hole, and the other end of each of the at least one cable is fixed on the bottom surface through the corresponding cable fixing hole.

5. The device for improving power efficiency of a grow light as claimed in claim 3, wherein each of the at least one scissor extension further includes:
two connecting arms, each of the two connecting arms being elongated and having two ends, and each of the two ends having a respective hole;
wherein each of the two connecting arms is pivotally connected to one end of the at least one set of connected multi-piece scissors structure via the hole on one of the two ends of each connecting arm.

6. The device for improving power efficiency of a grow light as claimed in claim 5, wherein the base further includes:
a bottom surface, correspondingly provided with a cable fixing hole for each of the at least one cable;
at least one sidewall, each of which is provided with two fixing holes;
wherein one of the at least one scissor extension and one of the at least one sidewall of the base are respectively pivotally connected to the two fixing holes through the holes at the other ends of the two connecting arms, and the other end of each of the at least one cable is fixed on the bottom surface through the corresponding cable fixing hole.

7. The device for improving power efficiency of a grow light as claimed in claim 1, wherein the sensing device measures a relative position between a plant and the sensing device, and transmits information of the relative position to the control module, and the control module adjusts the distance between the light fixture and the plant by controlling the available cable length of each of the at least one cable according to information of the relative position.

8. A device for improving power efficiency of a grow light, the device used for setting a sensing device and a light fixture, and the device including:
a control device having at least one cable, each of the at least one cable having two ends, one of which is controlled by the control device to change an available cable length of each of the at least one cable;
a base connected to the other end of each of the at least one cable;
wherein the base is suspended below the control device by the at least one cable, and a distance between the control device and the base is changeable by adjusting the available cable length of each of the at least one cable;
wherein the sensor device and the light fixture are further connected under the base.

9. The device for improving power efficiency of a grow light as claimed in claim 8, wherein the control device further includes
a bottom plate having:
a rotating shaft, which is elongated and has two ends;
a motor that provides a torque to the rotating shaft;
a bearing, together with the motor respectively pivotally connected with the two ends of the rotating shaft, and the rotating shaft being rotatable by the motor;
a control module, which controls the motor to rotate in a first rotation direction or a second rotation direction;
a spool fixed on the rotating shaft and being rotatable with the rotating shaft;
wherein one of the two ends of each of the at least one cable is wound around the spool, and is controlled by the control device, such that each of the at least one cable is further wound around or loosened from the spool;
wherein, when the control module controls the motor to rotate in the first rotation direction, each of the at least one cable is further wound around the spool, so that the available cable length of each of the at least one cable is getting shorter, and when the control module controls the motor to rotate in the second rotation direction, each of the at least one cable is released from the spool, so that the available cable length of each of the at least one cable is getting longer.

10. The device for improving power efficiency of a grow light as claimed in claim 9, wherein the base further includes
a bottom surface, correspondingly provided with a cable fixing hole for each of the at least one cable;
wherein the other end of each of the at least one cable is fixed on the bottom surface through the corresponding cable fixing hole.

11. The device for improving power efficiency of a grow light as claimed in claim 8, wherein the sensing device measures a relative position between a plant and the sensing device, and transmits information of the relative position to the control module, and the control module adjusts the distance between the light fixture and the plant by controlling the available cable length of each of at least one cable according to the information of relative position.
